(19) United States
(12) Patent Application Publication
(10) Pub. No.: US 2013/0158762 A1
(43) Pub. Date: Jun. 20, 2013

(54) STRUCTURE FOR ENERGY MANAGEMENT SYSTEM AND ENERGY MANAGEMENT METHOD IN ELECTRIC VEHICLE

(71) Applicant: Electronics and Telecommunications Research Institute, Daejeon (KR)

(72) Inventors: Yoon Young AN, Daejeon (KR); Chang Min PARK, Daejeon (KR); Wung PARK, Cheongju-si (KR); Pyung Dong CHO, Daejeon (KR)

(73) Assignee: Electronics and Telecommunications Research Institute, Daejeon (KR)

(21) Appl. No.: 13/713,652

(22) Filed: Dec. 13, 2012

(30) Foreign Application Priority Data
Dec. 14, 2011 (KR) 10-2011-0134401

(51) Int. Cl. G06F 17/00

(52) U.S. Cl. CPC G06F 17/00
USPC 701/22

(57) ABSTRACT

Provided is an energy management system installed in an electric vehicle, including: a mobile communication interface module to perform communication between an electric vehicle charging station management center and the electric vehicle over a mobile communication network; a charging station information receiving module to receive information about a charging station providing charging of electric energy; a vehicle battery state information receiving module to receive information about a battery state of the electric vehicle from a battery management module; an energy control algorithm module to generate control information about a usage of the electric energy based on information about the battery state and information about the charging station; and an energy control module to individually generate a control command with respect to a power usage of an apparatus that is managed by each of a vehicle control system associated, a vehicle multimedia system, and a service management system.

### CROSS-REFERENCE TO RELATED APPLICATION

This application claims the priority benefit of Korean Patent Application No. 10-2011-0134401, filed on Dec. 14, 2011, in the Korean Intellectual Property Office, the disclosure of which is incorporated herein by reference.

BACKGROUND

1. Field of the Invention

The following embodiments of the present invention relate to various systems, such as a vehicle control system, a multimedia control system, and a service management system that are provided within an electric vehicle for vehicle management in association with an electric vehicle and charging system field that is a major field of a smart grid, a structure of an energy management system for controlling an energy usage of devices that are managed by the systems, and an energy management method.

2. Description of the Related Art

An existing in-vehicle management system generally includes a vehicle control system for controlling a device of a vehicle, a multimedia control system for controlling multimedia apparatuses installed within the vehicle, and a service management system for providing a navigation service, a traffic information service, and the like. However, an electric vehicle operates the above installed systems by charging a battery with electricity. Accordingly, the electric vehicle needs to be distinguished from a vehicle that is driven using an existing fuel such as gasoline, diesel, a liquefied petroleum gas (LPG), and the like.

A petrol station or a gas station that supplies the existing fuel may easily store a fuel. Gas or oil has a high accessibility and prices of gas or oil do not significantly vary. However, battery technology for storing electric energy has not been greatly developed and the respective electricity charging stations may encounter with different power supply circumstances and thus, prices of electric energy may relatively greatly vary. Accordingly, an electric vehicle may need to manage and control an in-vehicle energy usage.

### SUMMARY

An aspect of the present invention provides a structure of an energy management system that enables an electric vehicle to control an in-vehicle energy usage to be suitable for an available energy state of the vehicle, based on information about a current battery state and information about an available charging station, and an operation method thereof.

According to an aspect of the present invention, there is provided an energy management system installed in an electric vehicle, the system including: a mobile communication interface module to perform communication between an electric vehicle charging station management center and the electric vehicle over a mobile communication network; a charging station information receiving module to receive information about a charging station that provides charging of electric energy; a vehicle battery state information receiving module to receive information about a battery state of the electric vehicle from a battery management module; an energy control algorithm module to generate control information about a usage of the electric energy based on information about the battery state and information about the charging station; and an energy control module to individually generate a control command with respect to a power usage of an apparatus that is managed by each of a vehicle control system associated with a mechanical motion of the electric vehicle, a vehicle multimedia system associated with multimedia apparatuses installed within the electric vehicle, and a service management system associated with a service using the mobile communication network.

Each of the vehicle control system, the vehicle multimedia system, and the service management system may include an energy control module, and each of the vehicle control system, the vehicle multimedia system, and the service management system may individually control a power usage using the energy control module in response to the control command. Information about the battery state may include information about a currently available battery amount.

Information about the charging station may include at least one of a distance between the electric vehicle and the charging station, information regarding whether the charging station is present in a path between a current position of the electric vehicle and a destination, and information about a charging time at the charging station.

The vehicle control system may manage at least one of an air conditioner, a heater, and an engine motor of the electric vehicle.

The vehicle multimedia system may manage at least one of a radio, an audio player, and a video player.

The service management system may manage an apparatus associated with a navigation service or a traffic information service.

The energy control module may individually generate the control command to power on or off the apparatus that is managed by each of the vehicle control system, the vehicle multimedia system, and the service management system.

According to another aspect of the present invention, there is provided an electric vehicle, including: a battery to store electric energy; a battery management module to manage the battery; and an energy management system to receive, from an electric vehicle charging station management center over a mobile communication network, information about a charging station that provides charging of the electric energy, to generate control information about a usage of the electric energy based on information about the charging station and information about a battery state of the electric vehicle that is received from the battery management module, and to individually generate a control command with respect to a power usage of an apparatus that is managed by each of a vehicle control system associated with a mechanical motion of the electric vehicle, a vehicle multimedia system associated with multimedia apparatuses installed within the electric vehicle, and a service management system associated with a service using the mobile communication network.

Each of the vehicle control system, the vehicle multimedia system, and the service management system may include an energy control module, and each of the vehicle control system, the vehicle multimedia system, and the service management system may individually control a power usage using the energy control module in response to the control command.

The energy management system may individually generate the control command to power on or off the apparatus that is managed by each of the vehicle control system, the vehicle multimedia system, and the service management system.

Information about the charging station may include at least one of a distance between the electric vehicle and the charging station, information regarding whether the charging station is present in a path between a current position of the electric vehicle and a destination, and information about a charging time at the charging station.

Information about the battery state may include information about a currently available battery amount.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a network including an electric vehicle charging station management center associated with a vehicle, a traffic information management center, and an electric vehicle charging station according to an embodiment of the present invention;

FIG. 2 is a block diagram illustrating an internal structure of a vehicle in the network of FIG. 1 according to an embodiment of the present invention; and

FIG. 3 is a block diagram illustrating an energy management system according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

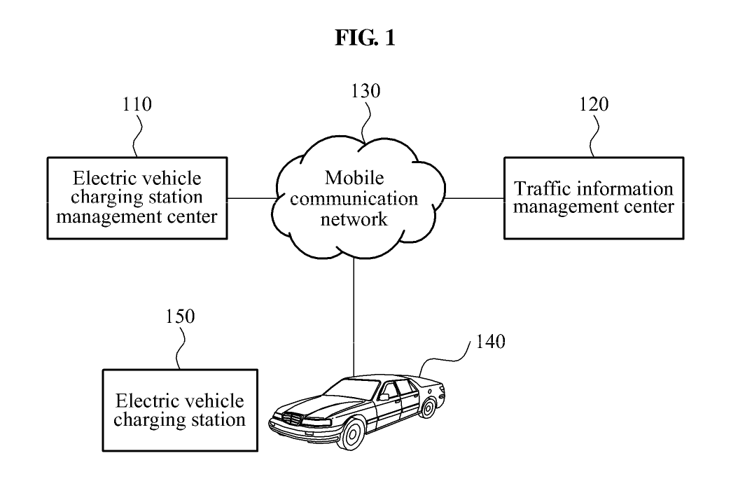

FIG. 1 is a diagram illustrating a network including an electric vehicle charging station management center 110 associated with a vehicle 140, a traffic information management center 120, and an electric vehicle charging station 150 according to an embodiment of the present invention.

As shown in FIG. 1, the vehicle 140 may communicate with the electric vehicle charging station management center 110 and the traffic information management center 120 over a mobile communication network 130. In particular, the electric vehicle charging station management center 110 may inform the vehicle 140 about a position of the electric vehicle charging station 150 close to the vehicle 140, and may also inform the vehicle 140 about prices of electric energy and the like. Also, the traffic information management information center 120 may provide the vehicle 140 with traffic information.

Hereinafter, a further detailed description will be made.

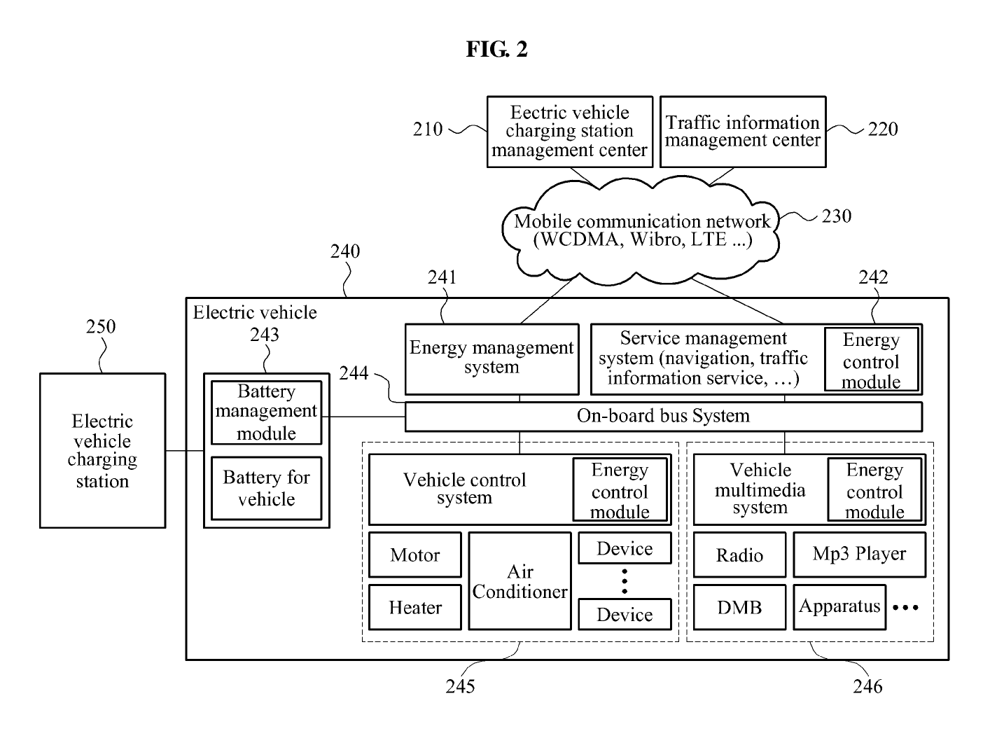

FIG. 2 is a block diagram illustrating an internal structure of a vehicle in the network of FIG. 1.

Referring to FIG. 2, the network may include an electric vehicle charging station management center 210, a traffic information management center 220, a mobile communication network 230, an electric vehicle 240, and an electric vehicle charging station 250.

The electric vehicle 240 may include a vehicle control system 245, a vehicle multimedia system 246, a service management system 242, an energy management system 241, and a battery management system 243.

For charging, the electric vehicle 240 may have an interface for the electric vehicle charging station 250, and may exchange information with the electric vehicle charging station management center 210 and the traffic information management center 220 over the mobile communication network 230. The mobile communication network 230 may employ various communication technologies such as a wireless code division multiple access (WCDMA), wireless broadband Internet (WiBro), long term evolution (LTE), and the like.

The vehicle control system 245 may manage power of an engine motor, an air conditioner, a heater, and various apparatuses of the electric vehicle 240, and may include an energy control module.

The vehicle multimedia system 246 may control power of various multimedia apparatuses such as a radio, an MP3 player, a digital multimedia broadcasting (DMB) player, a video player, and the like installed within the vehicle, and may include an energy control module.

The service management system 242 may include apparatuses for various on-board services such as a navigation service, a traffic information service, and the like, and may exchange information with an external server such as the traffic information management center 220 through a mobile communication module such as a WCDMA, a WiBbro, LTE, and the like. Also, the service management system 242 may include an energy control module.

A battery management module included in the battery management system 243 may exchange information required to charge a battery from the electric vehicle charging station 250. The battery management module may exchange information required to charge the battery from the electric vehicle charging station 250. The battery management module 243 may manage the battery and may transmit information about a battery state to the energy management system 241.

Using an on-board bus system 244, the energy management system 241 may control a power usage of the service management system 242, the vehicle control system 245, and the vehicle multimedia system 246 within the electric vehicle 240.

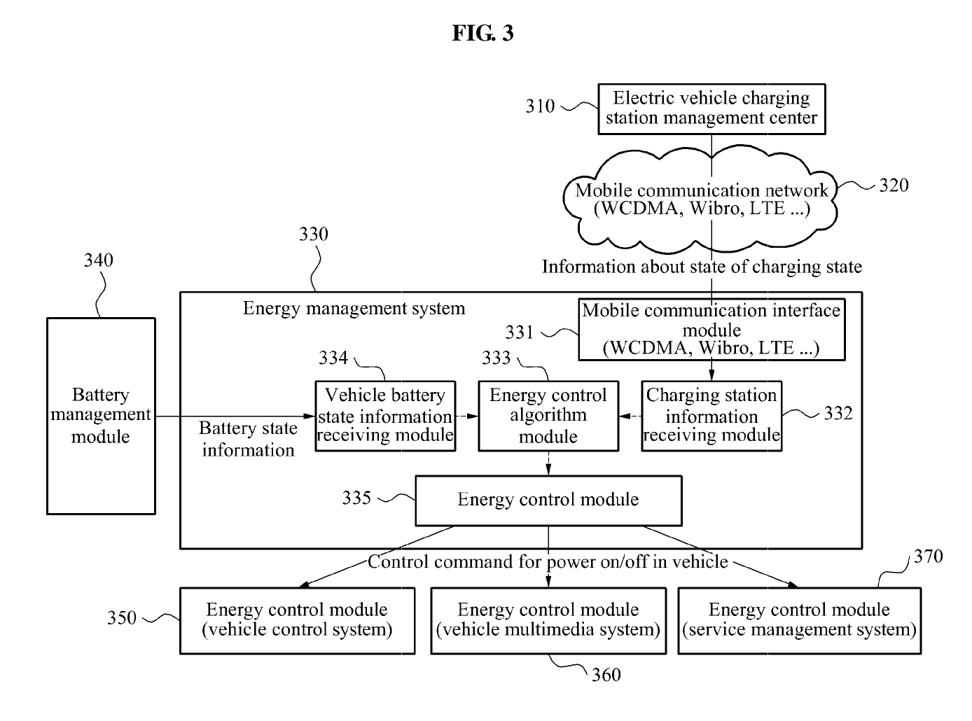

FIG. 3 is a block diagram illustrating an energy management system 330 according to an embodiment of the present invention.

Referring to FIG. 3, the energy management system 300 may include a mobile communication interface module 331, a charging station information receiving module 332, an energy control algorithm module 333, a vehicle battery state information receiving module 334, and an energy control module 335.

The mobile communication interface module 331 is an interface module to perform communication between an electric vehicle charging station management center 310 and an electric vehicle over a mobile communication network 320.

The charging station information receiving module 332 may receive information about a charging station from the electric vehicle charging station management center 310 over the mobile communication network 320. Here, information about the charging station may include at least one of a distance between the electric vehicle and the charging station, information regarding whether the charging station is present in a path between a current position of the electric vehicle and a destination, and information about a charging time at the charging station.

The vehicle battery state information receiving module 334 may receive battery state information about the electric vehicle from a battery management module 340. Here, battery state information may include information about a currently available battery amount.

The energy control algorithm module 333 may generate control information about a usage of electric energy based on information about the battery state and information about the charging station. In particular, the energy control algorithm module 333 may generate control information about a usage of electric energy based on a currently available battery amount, a position of the charging station, a charging time, and the like.

For example, when the currently available battery amount is relatively great, but the charging station is positioned to be relatively far, the usage of electric energy may be greatly constrained. On the other hand, when the currently available battery amount is relatively small, but the charging station is positioned to be relatively close, the usage of electric energy may be less limited.

Also, the energy control module 335 may individually generate a control command with respect to a power usage of an apparatus that is managed by each of a vehicle control system 350 associated with a mechanical motion of the electric vehicle, a vehicle multimedia system 360 associated with multimedia apparatuses installed within the electric vehicle, and a service management system 370 associated with a service using the mobile communication network 320.

Each of the vehicle control system 350, the vehicle multimedia system 360, and the service management system 370 may include an energy control module. Each of the vehicle control system 350, the vehicle multimedia system 360, and the service management system 370 may individually control a power usage using the energy control module in response to the control command.

For example, power ON/OFF of each of the vehicle control system 350, the vehicle multimedia system 360, and the service management system 370 may be individually controlled such as a case in which the vehicle control system 350 is powered on and the vehicle multimedia system 360 is powered off.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

According to embodiments of the present invention, there is provided a structure of an energy management system that enables an electric vehicle to control an in-vehicle energy usage to be suitable for an available energy state of the vehicle, based on information about a current battery state and information about an available charging station, and an operation method thereof. Therefore, it is possible to enhance the energy usage efficiency in the electric vehicle, and to efficiently operate a charging system.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An energy management system installed in an electric vehicle, the system comprising:
a mobile communication interface module to perform communication between an electric vehicle charging station management center and the electric vehicle over a mobile communication network;
a charging station information receiving module to receive information about a charging station that provides charging of electric energy;
a vehicle battery state information receiving module to receive information about a battery state of the electric vehicle from a battery management module;
an energy control algorithm module to generate control information about a usage of the electric energy based on information about the battery state and information about the charging station; and
an energy control module to individually generate a control command with respect to a power usage of an apparatus that is managed by each of a vehicle control system associated with a mechanical motion of the electric vehicle, a vehicle multimedia system associated with multimedia apparatuses installed within the electric vehicle, and a service management system associated with a service using the mobile communication network.

2. The system of claim 1, wherein:
each of the vehicle control system, the vehicle multimedia system, and the service management system comprises an energy control module, and
each of the vehicle control system, the vehicle multimedia system, and the service management system individually controls a power usage using the energy control module in response to the control command.

3. The system of claim 1, wherein information about the battery state comprises information about a currently available battery amount.

4. The system of claim 1, wherein information about the charging station comprises at least one of a distance between the electric vehicle and the charging station, information regarding whether the charging station is present in a path between a current position of the electric vehicle and a destination, and information about a charging time at the charging station.

5. The system of claim 1, wherein the vehicle control system manages at least one of an air conditioner, a heater, and an engine motor of the electric vehicle.

6. The system of claim 1, wherein the vehicle multimedia system manages at least one of a radio, an audio player, and a video player.

7. The system of claim 1, wherein the service management system manages an apparatus associated with a navigation service or a traffic information service.

8. The system of claim 1, wherein the energy control module individually generates the control command to power on or off the apparatus that is managed by each of the vehicle control system, the vehicle multimedia system, and the service management system.

9. An electric vehicle, comprising:
a battery to store electric energy;
a battery management module to manage the battery; and
an energy management system to receive, from an electric vehicle charging station management center over a mobile communication network, information about a charging station that provides charging of the electric energy, to generate control information about a usage of the electric energy based on information about the charging station and information about a battery state of the electric vehicle that is received from the battery management module, and to individually generate a control command with respect to a power usage of an apparatus that is managed by each of a vehicle control system associated with a mechanical motion of the electric vehicle, a vehicle multimedia system associated with multimedia apparatuses installed within the electric vehicle, and a service management system associated with a service using the mobile communication network.

10. The electric vehicle of claim 9, wherein:
each of the vehicle control system, the vehicle multimedia system, and the service management system comprises an energy control module, and
each of the vehicle control system, the vehicle multimedia system, and the service management system individually controls a power usage using the energy control module in response to the control command.

11. The electric vehicle of claim 9, wherein the energy management system individually generates the control command to power on or off the apparatus that is managed by each of the vehicle control system, the vehicle multimedia system, and the service management system.

12. The electric vehicle of claim 9, wherein information about the charging station comprises at least one of a distance between the electric vehicle and the charging station, information regarding whether the charging station is present in a path between a current position of the electric vehicle and a destination, and information about a charging time at the charging station.

13. The electric vehicle of claim 9, wherein information about the battery state comprises information about a currently available battery amount.
